(19) United States
(12) Patent Application Publication
(10) Pub. No.: US 2021/0273372 A1
(43) Pub. Date: Sep. 2, 2021

(54) MOUNTING STRUCTURE FOR WATERPROOF CONNECTOR AND WATERPROOF CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Akihiro NISHITANI, Mie (JP); Yasuo OMORI, Mie (JP)

(21) Appl. No.: 17/253,309

(22) PCT Filed: Jun. 20, 2019
(86) PCT No.: PCT/JP2019/024398

§ 371 Date: Dec. 17, 2020

(30) Foreign Application Priority Data
Jun. 29, 2018 (JP) 2018-124536

(51) Int. Cl. H01R 13/52; H01R 13/74

(52) U.S. Cl. CPC H01R 13/5202; H01R 2201/26; H01R 13/748

(57) ABSTRACT

It is aimed to prevent water having intruded into a gap between a panel and a flange portion from remaining in the gap. A mounting structure for waterproof connector (13) is provided with a panel (10) formed with a through hole (11) and a waterproof connector (13). The waterproof connector 13 includes a connector housing (15) to be passed through the through hole (11) and a flange portion (16) formed on an outer periphery of the connector housing (15). A sealing ring (21) to be held in close contact with the panel (10) while surrounding the through hole (11) is mounted on the flange portion (16). A drain hole (12) is disposed between a hole edge part of the through hole (11) of the panel (10) and the sealing ring (21).

The present invention relates to a mounting structure for waterproof connector land a waterproof connector.

### BACKGROUND

Patent Document 1 discloses a structure for mounting a waterproof connector on a panel. The waterproof connector includes a connector body, a sealing ring and terminal fittings. The connector body includes a connector housing for accommodating the terminal fittings, and a flange portion formed on the outer periphery of the connector housing. The sealing ring is mounted in a sealing groove formed in the flange portion.

In mounting the waterproof connector on the panel, the connector housing is passed through a through hole of the panel, the flange portion is overlapped on a surface of the panel, and the sealing ring is held in close contact with the surface of the panel. Since the sealing ring is disposed to surround the through hole over the entire periphery, even if the surface of the panel is wetted with water, there is no possibility that water intrudes to a back surface side of the panel through a clearance between the through hole and the connector housing.

### PRIOR ART DOCUMEENT

### Patent Document

Patent Document 1: JP H11-339880 A

### SUMMARY OF THE INVENTION

### Problems to Be Solved

In the case of a structure in which the sealing ring of the waterproof connector is held in close contact with the panel from a wetting side, even if water intrudes into a gap between the panel and the flange portion, that water flows down along the outer periphery of the sealing ring. Thus, there is little possibility that the water remains between the panel and the flange portion.

However, in the case of a structure in which the sealing ring is held in close contact with the panel from a side opposite to the wetting side, water having intruded into the gap between the panel and the flange portion through the through hole is received by the inner peripheral surface of the sealing ring. Thus, the water remains in the gap between the panel and the flange portion.

The present invention was completed on the basis of the above situation and aims to prevent water having intruded into a gap between a panel and a flange portion from remaining in the gap.

### Means to Solve the Problem

A first aspect of the present invention is directed to a mounting structure for waterproof connector with a panel formed with a through hole and a waterproof connector, wherein the waterproof connector includes a connector housing to be passed through the through hole and a flange portion formed on an outer periphery of the connector housing, a sealing ring to be held in close contact with the panel while surrounding the through hole is mounted on the flange portion, and a drain hole is disposed between a hole edge part of the through hole of the panel and the sealing ring.

A second aspect of the present invention is directed to a waterproof connector mountable on a panel formed with a through hole and a drain hole, the waterproof connector including a connector housing to be passed through the through hole, and a flange portion formed on an outer periphery of the connector housing, wherein a sealing ring to be held in close contact with the panel to surround the through hole and the drain hole is mounted on the flange portion, and a projection to be accommodated into the drain hole with a clearance formed therebetween is formed on the flange portion.

### Effect of the Invention

According to the first aspect of the invention, even if water intrudes into a gap between the panel and the flange portion through the through hole, that water is discharged to the outside of the gap through the drain hole. According to the second aspect of the invention, since the waterproof connector is positioned with respect to the panel by fitting the projection and the drain hole, the drain hole is arranged in a region surrounded by the sealing ring. Even if water intrudes into the gap between the panel and the flange portion through the through hole, that water is discharged to the outside of the gap through the drain hole.

### BRIEF DESCRIPTION OF THE DRAWINGS

FIG. 1 is a front view showing a connector mounting structure of a first embodiment.

FIG. 2 is a section along X-X of FIG. 1.

FIG. 3 is a partial enlarged front view showing a state where a projection is fit in a drain hole.

FIG. 4 is a perspective view of the projection.

FIG. 5 is a perspective view of a projection of a second embodiment.

FIG. 6 is a partial enlarged section showing a state where the projection of the second embodiment is fit in a drain hole.

FIG. 7 is a perspective view of a projection of a third embodiment.

FIG. 8 is a partial enlarged section showing a state where the projection of the third embodiment is fit in a drain hole.

FIG. 9 is a partial enlarged front view showing a state where a projection of a fourth embodiment is fit in a drain hole.

FIG. 10 is a partial enlarged front view showing a state where a projection of a fifth embodiment is fit in a drain hole.

FIG. 11 is a partial enlarged front view showing a state where a projection of a sixth embodiment is fit in a drain hole.

FIG. 12 is a partial enlarged front view showing a state where a projection of a seventh embodiment is fit in a drain hole.

FIG. 13 is a partial enlarged front view showing a state where a projection of an eighth embodiment is fit in a drain hole.

FIG. 14 is a partial enlarged front view showing a state where a projection of a ninth embodiment is fit in a drain hole.

FIG. 15 is a partial enlarged front view showing a state where a projection of a tenth embodiment is fit in a drain hole.

### DETAILED DESCRIPTION TO EXECUTE THE INVENTION

The first aspect of the invention may be such that the panel is vertically arranged, and the drain hole is disposed at a position below the through hole. According to this configuration, the water having intruded into the gap between the panel and the flange portion is discharged to the outside of the gap from the drain hole by its own weight.

The first aspect of the invention may be such that a projection to be accommodated into the drain hole with a clearance formed therebetween is formed on the flange portion. According to this configuration, since the waterproof connector is positioned with respect to the panel by fitting the projection and the drain hole, the drain hole is arranged in the region surrounded by the sealing ring. In this way, the water in the gap between the panel and the flange portion can be reliably discharged. The first aspect of the invention may be such that the panel is vertically arranged, the drain hole is disposed at a position below the through hole, a projection to be accommodated into the drain hole with a clearance formed therebetween is formed on the flange portion, and an outer periphery lowest end of the projection is set substantially at the same height as an inner periphery lowest end of the sealing ring. According to this configuration, the water having intruded into the gap between the panel and the flange portion can be discharged to the outside of the gap without almost remaining in the gap.

The first aspect of the invention may be such that a recess for partially enlarging an interval to the hole edge part of the drain hole is formed in an outer periphery of the projection. According to this configuration, drainage efficiency in the recess can be enhanced without impairing a function of positioning the waterproof connector with respect to the panel.

The second aspect of the invention may be such that the panel is vertically arranged and the waterproof connector is mountable on the panel in which the drain hole is disposed at a position below the through hole, and an outer periphery lowest end of the projection is set substantially at the same height as an inner periphery lowest end of the sealing ring. According to this configuration, the water having intruded into the gap between the panel and the flange portion can be discharged to the outside of the gap without almost remaining in the gap.

The second aspect of the invention may be such that a recess for partially enlarging an interval to a hole edge part of the drain hole is formed in an outer periphery of the projection. According to this configuration, the drainage efficiency in the recess can be enhanced without impairing the function of positioning the waterproof connector with respect to the panel.

### First Embodiment

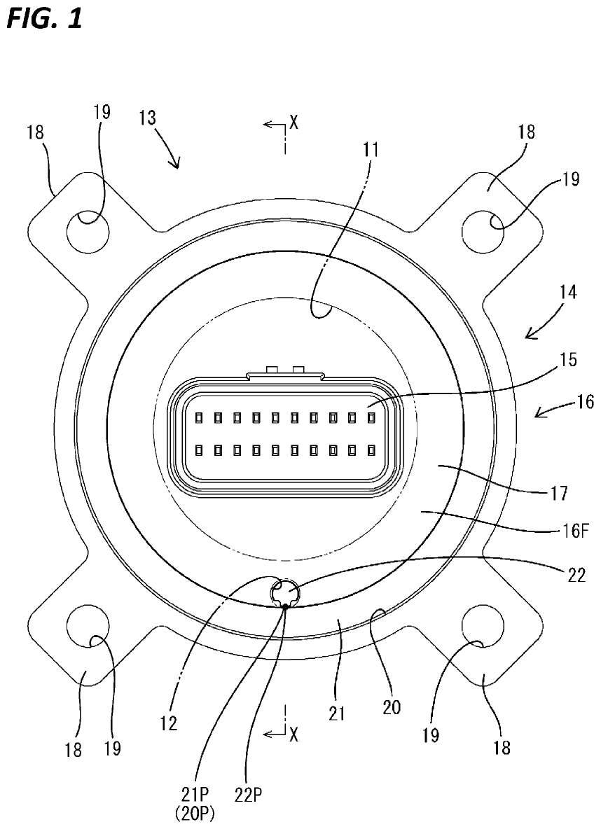

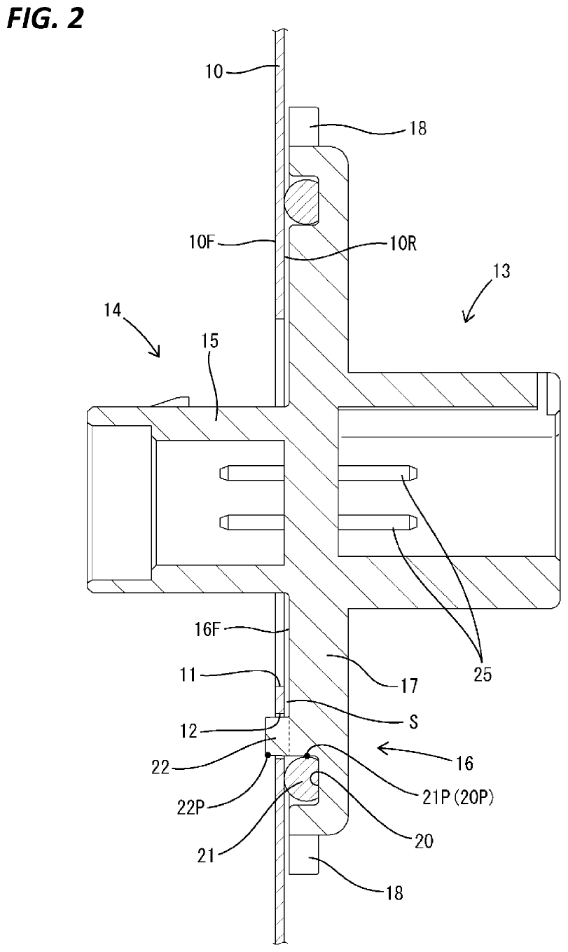

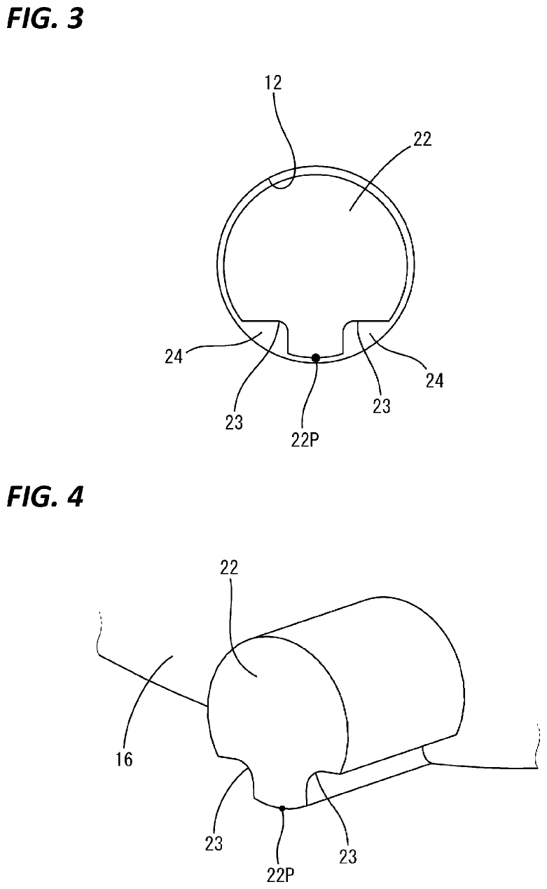

Hereinafter, a first specific embodiment of the present invention is described with reference to FIGS. 1 to 4. Note that, in the following description, a left side in FIG. 2 is defined as a front side concerning a front-rear direction. Upper and lower sides shown in FIGS. 1 to 4 are directly defined as upper and lower sides concerning a vertical direction. Left and right sides shown in FIGS. 1 and 3 are directly defined as left and right sides concerning a lateral direction.

A mounting structure of the first embodiment for mounting a waterproof connector 13 on a panel 10 can be applied to an automotive vehicle. The panel 10 is provided in the vertical direction to partition between an engine compartment (not shown) where there is a possibility of water-wetting and a vehicle interior (not shown) where there is no possibility of water-wetting. Specifically, both front and rear plate surfaces of the panel 10 are parallel to the vertical direction and the panel 10 is so provided that a plate thickness direction is oriented in the front-rear direction.

As shown in FIG. 2, the panel 10 is formed with a circular through hole 11 penetrating in the plate thickness direction thereof, a circular drain hole 12 likewise penetrating in the plate thickness direction, and a plurality of (four in the first embodiment) mounting holes (not show). An inner diameter of the drain hole 12 is set smaller than that of the through hole 11. The drain hole 12 is arranged at a position below a lower end of the through hole 11 (position right below the through hole 11). The plurality of mounting holes are arranged at equal angular intervals on a circumference concentric with the through hole 11.

As shown in FIGS. 1 and 2, the waterproof connector 13 includes a connector body 14 made of synthetic resin, a resilient sealing ring 21 and terminal fittings 25 to be accommodated into the connector body 14. The connector body 14 is a single member including a connector housing 15 and a flange portion 16. The connector housing 15 is block-shaped and holds the terminal fittings 25. The flange portion 16 protrudes radially outward from the outer periphery of the connector housing 15.

The flange portion 16 is composed of a flange body portion 17 circular in a front view and a plurality of (as many as the mounting holes) mounting portions 18. The plurality of mounting portions 18 project radially outward from the outer periphery of the flange body portion 17. The plurality of mounting portions 18 are arranged at equal angular intervals in a circumferential direction on the outer peripheral edge of the flange body portion 17. Each mounting portion 18 is formed with a bolt hole 19 corresponding to the mounting hole.

A circular sealing groove 20 concentric with the flange portion 16 is formed in a front surface 16F of the flange portion 16 (flange body portion 17). An inner diameter of the sealing groove 20 is set larger than that of the through hole 11. A lowest part of a radially inner peripheral surface of the sealing groove 20 is defined as an inner periphery lowest end 20P of the sealing groove 20.

The sealing ring 21 is mounted in the sealing groove 20. With the sealing ring 21 mounted in the sealing groove 20 and the waterproof connector 13 not mounted on the panel 10, a front end part of the outer periphery of the sealing ring 21 projects slightly further forward than the front surface 16F of the flange portion 16. An inner peripheral part of the sealing ring 21 is radially facing the radially inner peripheral surface of the sealing groove 20. A lowest part of the inner peripheral part of the sealing ring 21 is defined as an inner periphery lowest end 21P of the sealing ring 21.

A projection 22 projecting forward is formed on the front surface of the flange portion 16. The projection 22 has a cylindrical shape having an axis oriented in the front-rear direction as a whole. A forward projecting dimension of the projection 22 is set larger than a thickness of the panel 10. A largest outer diameter of the projection 22 (height and width of the projection 22) is set slightly smaller than an inner diameter of the drain hole 12.

A pair of bilaterally symmetrical recesses 23 are formed in a lower end region of the outer periphery of the projection 22. The recesses 23 are formed from the front end (projecting end) to the rear end (base end) of the projection 22. The right recess 23 is open obliquely toward a right-lower side, and the left recess 23 is open obliquely toward a left-lower side. A cross-sectional shape and a cross-sectional area of the projection 22 including the recesses 23 perpendicular to the axis are the same over the entire length of the projection 22.

Further, a middle position between the both left and right recesses 23 on the outer periphery of the projection 22 is a lowest position on the outer periphery of the projection 22. This lowest part of the outer peripheral surface of the projection 22 is defined as an outer periphery lowest end 22P of the projection 22. The outer periphery lowest end 22P of the projection 22 is set at the same height as the inner periphery lowest end 20P of the sealing groove 20. Since the outer diameter of the projection 22 is smaller than the inner diameter of the sealing groove 20, the outer periphery of the projection 22 is in such a positional relationship as to be inscribed inside the radially inner peripheral surface of the sealing groove 20. With the sealing ring 21 mounted in the sealing groove 20, the outer periphery lowest end 22P of the projection 22 is substantially at the same height as the inner periphery lowest end 21P of the sealing ring 21.

The waterproof connector 13 is mounted on the panel 10 from a vehicle interior side (side of a rear surface 10R). In mounting, a front end part of the connector housing 15 is passed through the through hole 11 and the projection 22 is fit into the drain hole 12. By fitting the projection 22 into the drain hole 12, the waterproof connector 13 is substantially positioned with respect to the panel 10. By turning the waterproof connector 13 to left or right with the projection 22 as a fulcrum after the projection 22 is fit into the drain hole 12, the plurality of bolt holes 19 are set to correspond to the plurality of mounting holes. In this state, bolts (not shown) are inserted into the respective bolt holes 19 and the mounting holes, and nuts (not shown) screwed onto the bolts are tightened. In the above way, the waterproof connector 13 is fixed to the panel 10.

Since the panel 10 is somewhat curved during molding, a tiny gap S is formed between the rear surface 1OR of the panel 10 and the front surface 16F of the flange portion 16 with the waterproof connector 13 mounted on the panel 10. This gap S communicates with a space (engine compartment) on the side of a front surface 10F of the panel 10 via the through hole 11. Since the space on the side of the front surface 10F of the panel 10 is a region with a possibility of water-wetting, water may intrude into the gap S between the rear surface 10R of the panel 10 and the front surface 16F of the flange portion 16 through the through hole 11.

The water having intruded into the gap S flows down along the front surface 16F of the flange portion 16 and the rear surface 1OR of the panel 10 by its own weight and reaches the inner peripheral part of the sealing ring 21. The water having reached the vicinity of the inner periphery lowest end 21P of the sealing ring 21 is discharged toward the front surface 1OF of the panel 10 through a clearance 24 (see FIG. 3) between a hole edge part of the drain hole 12 and the outer peripheral surface of the projection 22. At this time, since the clearance 24 is large in the region where the recesses 23 are formed, water is efficiently discharged in a part where the recesses 23 are formed. Further, since regions of the inner peripheral part of the sealing ring 21 laterally separated from the inner periphery lowest end 21P (regions separated from the drain hole 12) are inclined, the water having reached these regions reaches the drain hole 12 by flowing down along the inner peripheral part and is discharged.

The mounting structure of the first embodiment includes the panel 10 formed with the through hole 11, and the waterproof connector 13. The waterproof connector 13 includes the connector housing 15 passed through the through hole 11 and the flange portion 16 formed on the outer periphery of the connector housing 15. The sealing ring 21 to be held in close contact with the panel 10 while concentrically surrounding the through hole 11 is mounted on the flange portion 16. The drain hole 12 is disposed between the hole edge part of the through hole 11 of the panel 10 and the sealing ring 21. Thus, even if water intrudes into the gap S between the panel 10 and the flange portion 16 through the through hole 11, that water is discharged to the outside of the gap S through the drain hole 12.

Further, the panel 10 is vertically arranged, and the drain hole 12 is disposed at a position below the through hole 11. Accordingly, water having intruded into the gap S between the panel 10 and the flange portion 16 is discharged to the outside of the gap S from the drain hole 12 by its own weight. Further, since the flange portion 16 is formed with the projection 22 to be accommodated in the drain hole 12 with the clearance 24 therebetween, the waterproof connector 13 is positioned with respect to the panel 10 by fitting the projection 22 and the drain hole 12. Since the drain hole 12 is arranged in a region surrounded by the sealing ring 21 in this way, the water in the gap S between the panel 10 and the flange portion 16 can be reliably discharged.

Further, since the outer periphery lowest end 22P of the projection 22 is set substantially at the same height as the inner periphery lowest end 21P of the sealing ring 21, water having intruded into the gas S between the panel 10 and the flange portion 16 can be discharged to the outside of the gap S without almost remaining in the gap S. Further, the recesses 23 for partially enlarging the gap to the hole edge part of the drain hole 12 is formed in the outer periphery of the projection 22. According to this configuration, drainage efficiency in the recesses 23 can be enhanced without impairing a function of positioning the waterproof connector 13 with respect to the panel 10.

### Second Embodiment

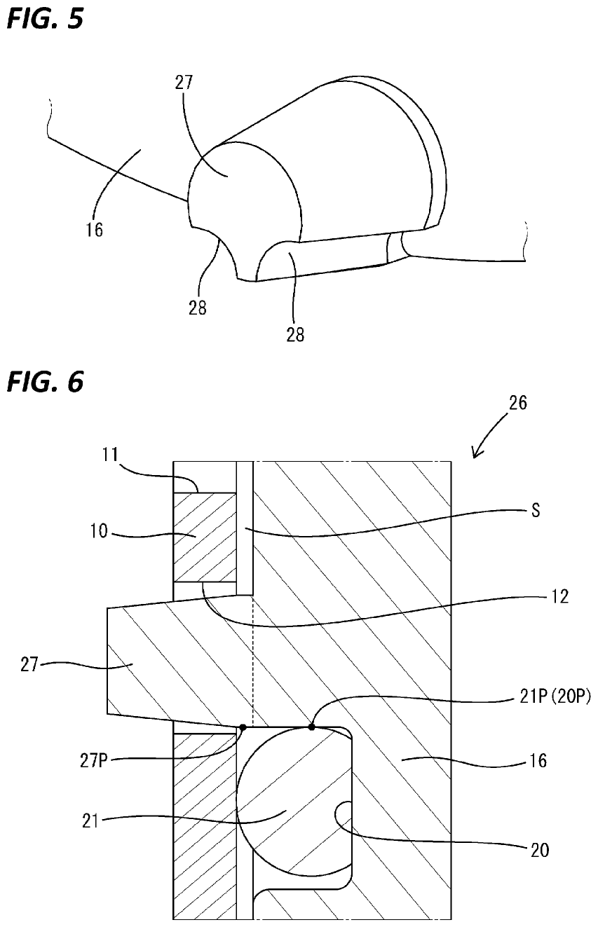

Next, a second specific embodiment of the present invention is described with reference to FIGS. 5 and 6. A waterproof connector 26 of the second embodiment is different from the above first embodiment in the configuration of a projection 27. Since the other configuration is the same as in the above first embodiment, the same components are denoted by the same reference signs and the structures, functions and effects thereof are not described.

The projection 27 of the second embodiment is changed from the projection 22 of the first embodiment by being tapered as a whole. The projection 27 of the second embodiment has a truncated conical shape (tapered shape) having an axis oriented in a front-rear direction. A forward projecting dimension of the projection 27 is set larger than a thickness of a panel 10. A largest outer diameter of the projection 27 (height and width of the projection 27 on the base end of the projection 27) is set slightly smaller than an inner diameter of a drain hole 12.

A pair of bilaterally symmetrical recesses 28 having the same shapes as those of the projection 22 of the first embodiment are formed in a lower end region of the outer periphery of the projection 27. The recesses 28 are formed from the front end (projecting end) to the rear end (base end) of the projection 27. The right recess 28 is open obliquely toward a right-lower side, and the left recess 28 is open obliquely toward a left-lower side. A cross-sectional shape of the projection 27 including the recesses 28 perpendicular to the axis is the same (similar shape) over the entire length of the projection 27. A cross-sectional area of the projection 27 including the recesses 28 perpendicular to the axis becomes gradually smaller from the base end (rear end) to the projecting end (front end) of the projection 27.

A middle position between the both left and right recesses 28 on the outer periphery of the projection 27 is a lowest position on the outer periphery of the projection 27. This lowest part of the outer peripheral surface of the projection 27 is defined as an outer periphery lowest end 27P of the projection 27. The outer periphery lowest end 27P of the projection 27 is set at the same height as an inner periphery lowest end 20P of a sealing groove 20. Since an outer diameter of the projection 27 is smaller than an inner diameter of the sealing groove 20, the outer periphery of the projection 27 is in such a positional relationship as to be inscribed inside a radially inner peripheral surface of the sealing groove 20. With the sealing ring 21 mounted in the sealing groove 20, the outer periphery lowest end 27P of the projection 27 is substantially at the same height as the inner periphery lowest end 21P of the sealing ring 21.

### Third Embodiment

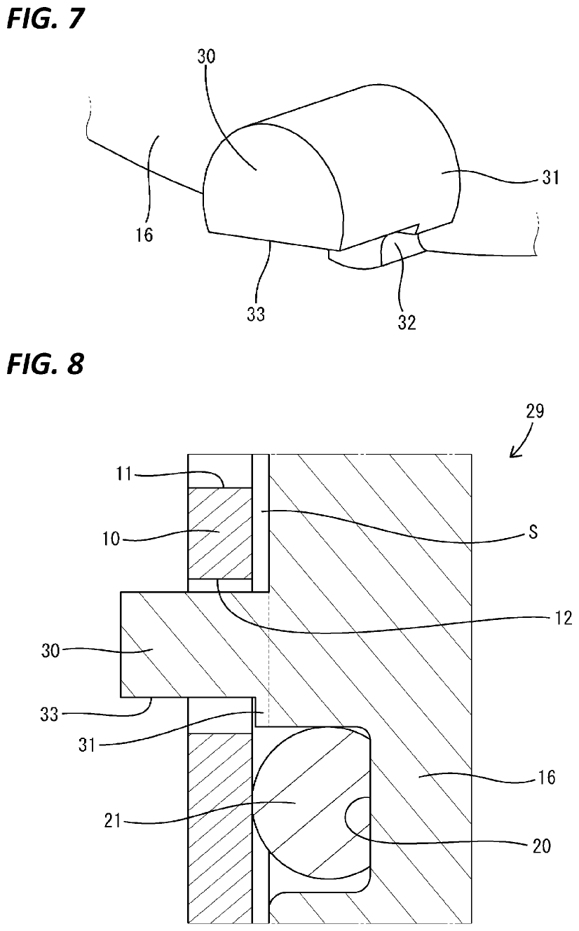

Next, a third specific embodiment of the present invention is described with reference to FIGS. 7 and 8. A waterproof connector 29 of the third embodiment is different from the above first embodiment in the configuration of a projection 30. Since the other configuration is the same as in the above first embodiment, the same components are denoted by the same reference signs and the structures, functions and effects thereof are not described. The projection 30 of the third embodiment is shaped by removing a part of a front end region of the projection 22 of the first embodiment. A base end part 31 (rear end part) of the projection 30 of the third embodiment has the same cross-sectional shape and cross-sectional area as the projection 22 of the first embodiment. That is, the base end part 31 of the projection 30 of the third embodiment is formed with a pair of bilaterally symmetrical recesses 32. A part of the projection 30 of the third embodiment forward of the base end part 31 is shaped by leaving only a region of the projection 22 of the first embodiment above the recesses 28. The part of the projection 30 of the third embodiment forward of the base end part 31 is formed with a cutout portion 33 for drainage largely spaced apart from a lower end region of a hole edge part of a drain hole 12.

### Fourth Embodiment

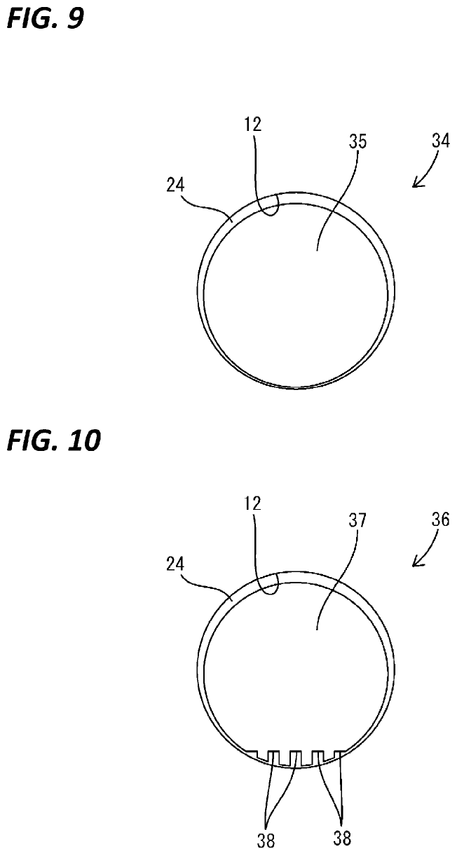

Next, a fourth specific embodiment of the present invention is described with reference to FIG. 9. A waterproof connector 34 of the fourth embodiment is different from the above first embodiment in the configuration of a projection 35. Since the other configuration is the same as in the above first embodiment, the same components are denoted by the same reference signs and the structures, functions and effects thereof are not described. The projection 35 of the fourth embodiment has a cylindrical shape having an axis oriented in a front-rear direction. The recesses 23 as formed on the projection 35 of the first embodiment are not formed on the outer periphery of the projection 35 of the fourth embodiment. An outer diameter of the projection 35 is set slightly smaller than an inner diameter of a drain hole 12. By this dimensioning, a clearance 24 for drainage is secured between the outer periphery of the projection 35 and a hole edge part of the drain hole 12.

### Fifth Embodiment

Next, a fifth specific embodiment of the present invention is described with reference to FIG. 10. A waterproof connector 36 of the fifth embodiment is different from the above first embodiment in the configuration of a projection 37. Since the other configuration is the same as in the above first embodiment, the same components are denoted by the same reference signs and the structures, functions and effects thereof are not described. The projection 37 of the fifth embodiment has a cylindrical shape having an axis oriented in a front-rear direction. A plurality of groove-like recesses 38 open downward are formed over the entire length of the projection 37 and arranged laterally in parallel in a lower end region of the outer periphery of the projection 37.

### Sixth Embodiment

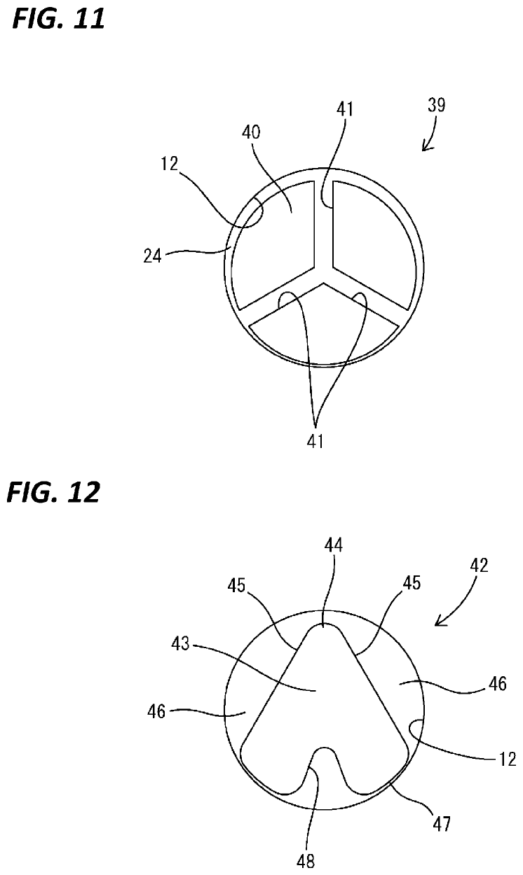

Next, a sixth specific embodiment of the present invention is described with reference to FIG. 11. A waterproof connector 39 of the sixth embodiment is different from the above first embodiment in the configuration of a projection 40. Since the other configuration is the same as in the above first embodiment, the same components are denoted by the same reference signs and the structures, functions and effects thereof are not described. The projection 40 of the sixth embodiment has a cylindrical shape having an axis oriented in a front-rear direction. The projection 40 is formed with a plurality of (three in the sixth embodiment) groove-like recesses 41 extending from the outer periphery thereof toward a radial center. The plurality of recesses 41 communicate in a center of the projection 40 in a front view.

### Seventh Embodiment

Next, a seventh specific embodiment of the present invention is described with reference to FIG. 12. A waterproof connector 42 of the seventh embodiment is different from the above first embodiment in the configuration of a projection 43. Since the other configuration is the same as in the above first embodiment, the same components are denoted by the same reference signs and the structures, functions and effects thereof are not described. The projection 43 of the seventh embodiment has a bilaterally symmetrical and substantially isosceles triangular shape having an upward facing top part 44 as a whole in a front view. Large drainage spaces 46 are formed between both left and right oblique side parts 45 of the outer periphery of the projection 43 and a hole edge part of a drain hole 12. A bottom side part 47 of the outer periphery of the projection 43 has an arcuate shape substantially along the hole edge part of the drain hole 12. A recess 48 is formed in a laterally central part of the bottom side part 47 of the projection 43. The projection 43 can contact the hole edge part of the drain hole 12 at the top part 44 and the arcuate bottom side part 47 and is positioned with respect to the drain hole 12 by these contacts.

### Eighth Embodiment

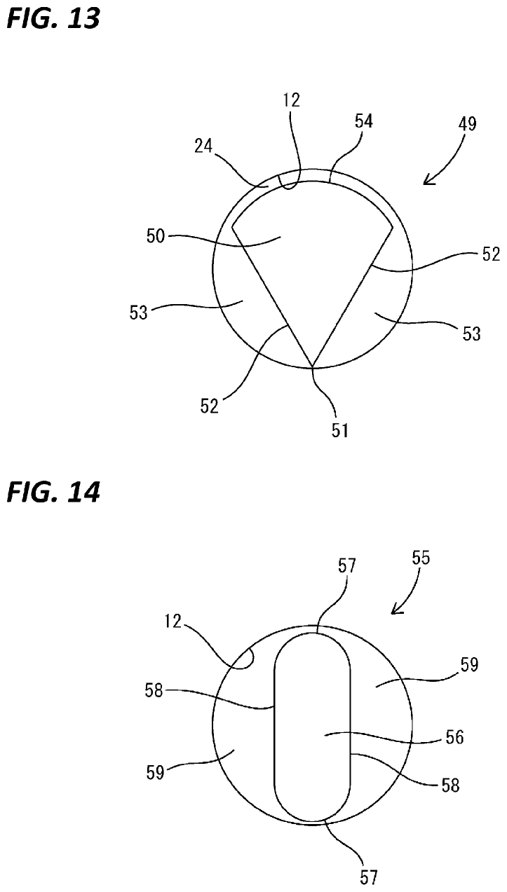

Next, an eighth specific embodiment of the present invention is described with reference to FIG. 13. A waterproof connector 49 of the eighth embodiment is different from the above first embodiment in the configuration of a projection 50. Since the other configuration is the same as in the above first embodiment, the same components are denoted by the same reference signs and the structures, functions and effects thereof are not described. The projection 50 of the eighth embodiment has a bilaterally symmetrical and substantially isosceles triangular shape having a downward facing vertex part 51 as a whole in a front view. Large drainage spaces 53 are formed between both left and right oblique side parts 52 of the outer periphery of the projection 50 and a hole edge part of a drain hole 12. The projection 50 can contact the hole edge part of the drain hole 12 at the vertex part 51 and an arcuate part 54 on an upper surface and is positioned with respect to the drain hole 12 by these contacts.

### Ninth Embodiment

Next, a ninth specific embodiment of the present invention is described with reference to FIG. 14. A waterproof connector 55 of the ninth embodiment is different from the above first embodiment in the configuration of a projection 56. Since the other configuration is the same as in the above first embodiment, the same components are denoted by the same reference signs and the structures, functions and effects thereof are not described. The projection 56 of the ninth embodiment has a bilaterally symmetrical oval shape elongated in a vertical direction as a whole in a front view. Semicircular parts 57 having a smaller radius of curvature than a hole edge part of a drain hole 12 are formed on both upper and lower end parts of the outer periphery of the projection 56. Large drainage spaces 59 are formed between both left and right side surface parts 58 of the outer periphery of the projection 56 and the hole edge part of the drain hole 12. The projection 56 can contact the hole edge part of the drain hole 12 at the both upper and lower semicircular parts 57 and is positioned with respect to the drain hole 12 by these contacts.

### Tenth Embodiment

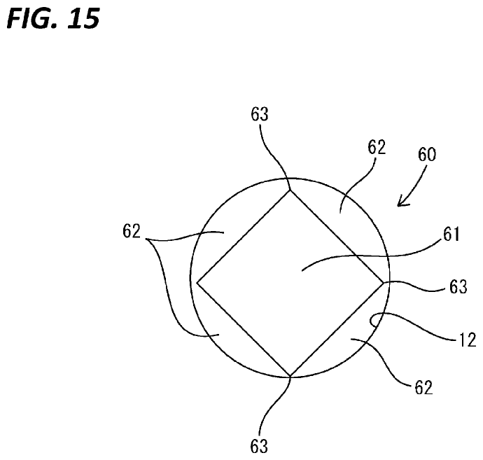

Next, a tenth specific embodiment of the present invention is described with reference to FIG. 15. A waterproof connector 60 of the tenth embodiment is different from the above first embodiment in the configuration of a projection 61. Since the other configuration is the same as in the above first embodiment, the same components are denoted by the same reference signs and the structures, functions and effects thereof are not described. The projection 61 of the tenth embodiment has a rhombic shape (square shape, four sides of which are obliquely inclined) as a whole in a front view. A length of diagonals of the projection 61 is equal to or slightly shorter than an inner diameter of a drain hole 12. Large drainage spaces 62 are formed between the outer periphery of the projection 61 and a hole edge part of the drain hole 12. The projection 61 can contact the hole edge part of the drain hole 12 at four vertex parts 63 (corner parts) and is positioned with respect to the drain hole 12 by these contacts.

### Other Embodiments

The present invention is not limited to the above described and illustrated embodiments. For example, the following embodiments are also included in the technical scope of the present invention.

(1) Although the panel is vertically arranged in the above first to tenth embodiments, the panel may be arranged obliquely to the vertical direction or may b

e horizontally arranged.

(2) Although the projection is formed on the flange portion in the above first to tenth embodiments, the projection may not be formed on the flange portion according to the present invention.

(3) Although the outer periphery lowest end of the projection is set substantially at the same height as the inner periphery lowest end of the sealing ring in the above first to tenth embodiments, the outer periphery lowest end of the projection may be set at a position higher than the inner periphery lowest end of the sealing ring.

(4) The form of the projection of the second embodiment changed by tapering the projection of the first embodiment as a whole can be applied to the fourth to tenth embodiments.

(5) The form of the projection of the third embodiment forming a second recess by cutting the front end region of the projection of the first embodiment except the base end part can be applied to the fourth to tenth embodiments.

### LIST OF REFERENCE NUMERALS

10 . . . panel

10F . . . front surface of panel

10R . . . rear surface of panel

11 . . . through hole

12 . . . drain hole

13, 26, 29, 34, 36, 39, 42, 49, 55, 60 . . . waterproof connector

14 . . . connector body

15 . . . connector housing

16 . . . flange portion

16F . . . front surface of flange portion

17 . . . flange body portion

18 . . . mounting portion

19 . . . bolt hole

20 . . . sealing groove

20P . . . inner periphery lowest end of sealing groove

21 . . . sealing ring

21 . . . inner periphery lowest end of sealing ring

22, 27, 30, 35, 37, 40, 43, 50, 56, 61 . . . projection

22P, 27P . . . outer periphery lowest end of projection

23, 28, 32, 38, 41, 48 . . . recess

24 . . . clearance
25 . . . terminal fitting
31 . . . base end part of projection
33 . . . cutout portion
44 . . . top part
45, 52 . . . oblique side part
46, 53, 59, 62 . . . drainage space
47 . . . bottom side part
51, 63 ... vertex part
54 . . . arcuate part
57 . . . semicircular part
58 . . . side surface part
S . . . gap

1. A mounting structure for waterproof connector, comprising:
a panel formed with a through hole and vertically arranged; and
a waterproof connector,
wherein:
the waterproof connector includes a connector housing to be passed through the through hole and a flange portion formed on an outer periphery of the connector housing,
a sealing ring to be held in close contact with the panel while surrounding the through hole is mounted on the flange portion,
a drain hole located below the through hole is disposed between a hole edge part of the through hole of the panel and the sealing ring,
a projection to be accommodated into the drain hole with a clearance formed therebetween is formed on the flange portion, and
an outer periphery lowest end of the projection is set substantially at the same height as an inner periphery lowest end of the sealing ring.

2-4.(canceled)

5. The mounting structure for waterproof connector of claim 1, wherein a recess for partially enlarging an interval to the hole edge part of the drain hole is formed in an outer periphery of the projection.

6. A waterproof connector mountable on a panel formed with a through hole and a drain hole disposed at a position below the through hole, the panel being vertically arranged, comprising:
a connector housing to be passed through the through hole; and
a flange portion formed on an outer periphery of the connector housing,
wherein:
a sealing ring to be held in close contact with the panel to surround the through hole and the drain hole is mounted on the flange portion,
a projection to be accommodated into the drain hole with a clearance formed therebetween is formed on the flange portion, and
an outer periphery lowest end of the projection is set substantially at the same height as an inner periphery lowest end of the sealing ring.

7. (canceled)

8. The waterproof connector of claim 6, wherein a recess for partially enlarging an interval to a hole edge part of the drain hole is formed in an outer periphery of the projection.
